(19) United States
(12) Patent Application Publication
(10) Pub. No.: US 2013/0105285 A1
(43) Pub. Date: May 2, 2013

(54) HANDLE SWITCH

(71) Applicants: Naoki NAKADA, Wako-shi (JP); Hiroyasu OTA, Wako-shi (JP)

(72) Inventors: Naoki NAKADA, Wako-shi (JP); Hiroyasu OTA, Wako-shi (JP)

(73) Assignee: HONDA MOTOR CO., LTD., Tokyo (JP)

(21) Appl. No.: 13/659,330

(22) Filed: Oct. 24, 2012

(30) Foreign Application Priority Data
Oct. 27, 2011 (JP) 2011-236383

(51) Int. Cl. H01H 9/06

(52) U.S. Cl. 200/61.54

(57) ABSTRACT

A handle switch wherein chattering after mounting of the handle switch to a handlebar can be restrained while maintaining assembleability of switch cases of bisection structure. The handle switch includes a first case and a second case of bisection structure formed with clamp surfaces making contact with the outer circumference of the handlebar of a motorcycle, the first case and the second case being coupled together, with the handlebar clamped between the clamp surfaces, to thereby fix the handle switch to the handlebar. At least one of the clamp surface formed in the first case and the clamp surface formed in the second case is formed with a rib serving as a fastening allowance in coupling the first case and the second case together. The width B of the rib is set to be smaller than the width A of the clamp surfaces.

### CROSS-REFERENCE TO RELATED APPLICATIONS

The present application claims priority under 35 USC 119 to Japanese Patent Application No. 2011-236383 filed Oct. 27, 2011 the entire contents of which are hereby incorporated by reference.

### BACKGROUND OF THE INVENTION

1. Field of the Invention

The present invention relates to a handle switch, particularly to a handle switch fixed to a handlebar of a motorcycle.

2. Description of Background Art

Hitherto, a handle switch is known wherein a switch case is provided with a plurality of operation switches fixed to a handlebar of a motorcycle, for permitting the rider to operate a horn and turn signal lamps and the like while gripping the handlebar. In many cases, such a handle switch is fastenedly fixed to the handlebar by a method wherein the switch case is designed to be of a bisection structure (composed of two case halves), and the outer circumferential surface of the handlebar is clamped from both sides by the two case halves, which are coupled together.

Japanese Patent Laid-Open No. 2005-271778 discloses a structure for a handle switch having a switch case of such a bisection structure as above-mentioned. The positioning projection provided on the switch case made of resin is engaged with a positioning hole provided in the handlebar to thereby position the switch case. In this structure, a core rod made of metal is passed through the positioning projection so that the switch case will not be positionally deviated even when a large external force is exerted on the switch case.

In the case of fixing such a switch case as above-mentioned to a handlebar, a configuration may be adopted wherein a clamp surface(s) on the switch case side is provided with a fastening allowance, in order that chattering would not be generated between the switch case and the handlebar. According to this configuration, it is possible to ensure that as the switch case halves are fastened to each other by a fastening member(s) such as a screw(s), the fastening allowance is collapsed to fill up the gap between the switch case halves, whereby chattering is prevented from occurring at the switch case.

Such a fastening allowance, however, has the following problem. If the fastening allowance is too small, the chatter-reducing effect is slight. On the other hand, if the fastening allowance is too large, it cannot easily be deformed, so that assembleability of the switch case may be lowered. For the handle switch described in Japanese Patent Laid-Open No. 2005-271778, nothing has been investigated about the setting of a suitable fastening allowance for realizing both a good chatter-reducing effect and high assembleability.

### SUMMARY AND OBJECTS OF THE INVENTION

It is an object of the present invention to provide a handle switch in which chattering after mounting of the handle switch onto a handlebar can be reduced while maintaining good assembleability of a switch case of a bisection structure, and by which the above-mentioned problem involved in the related art can be solved.

In order to attain the above object, according to an embodiment of the present invention, there is provided a handle switch including a first case (40) and a second case (41) of a bisection structure formed with clamp surfaces (40C, 41C) making contact with an outer circumference of a handlebar (14) of a motorcycle (1), the first case (40) and the second case (41) being coupled together, with the handlebar (14) clamped between the clamp surfaces (40C, 41C), to thereby fix the handle switch (30) to the handlebar (14). The at least one of the clamp surface (40C), framed in the first case (40), and the clamp surface (41C), formed in the second case (41), is formed with a rib (50U, 50L, 51U, 51L) serving as a fastening allowance in coupling the first case (40) and the second case (41) together. In addition, the width (B) of the rib (50U, 50L, 51U, 51L) is set to be smaller than the width (A) of the clamp surfaces (40C, 41C).

In addition, according to embodiment of the present invention the rib (50U, 50L, 51U, 51L) of the handle switch is not formed on those surfaces of the clamp surfaces (40C, 41C) which are substantially perpendicular to a coupling direction of the first case (40) and the second case (41), and a positioning projection (46) is formed in the coupling direction.

According to an embodiment of the present invention, the curvature of the clamp surfaces (40C, 41C) is set to be smaller than the curvature of an outer circumferential surface of the handlebar (14).

According to an embodiment of the present invention, the rib (50U, 50L, 51U, 51L) is formed in a small-width elongate shape extending along a circumferential direction of the clamp surfaces (40C, 41C).

According to an embodiment of the present invention, the first case (40) and the second case (41) are coupled together at a parting face (42) substantially perpendicular to the coupling direction of the first case (40) and the second case (41), and the rib (50U, 50L, 51U, 51L) is faulted in such a shape that its height decreases as one goes away from the parting face (42).

According to an embodiment of the present invention, the rib (50U, 50L, 51U, 51L) is formed in such a shape that its width decreases as one goes away from the parting face (42).

According to an embodiment of the present invention, the parting face (42) is provided with an offset along a direction of coming away from a rider, relative to an axis of the handlebar (14).

According to an embodiment of the present invention, at least one of the clamp surface formed in the first case and the clamp surface formed in the second case is formed with the rib serving as a fastening allowance in coupling the first case and the second case together, and the width of the rib is set to be smaller than the width of the clamp surfaces. Therefore, with the rib formed in a small-width shape, it is possible to reduce the force required for fastening the cases so as to fill up the gaps between the handlebar and the clamp surfaces. Accordingly, chattering of the switch case can be prevented, without lowering the assembleability of the handle switch. In addition, in the case where the switch case is formed from resin or the like by use of a mold, even after the formation of the mold it is possible to easily provide the rib, or to change the shape of the rib, by only cutting the mold half on one side.

According to the second characteristic, the rib is not formed on those surfaces of the clamp surfaces which are substantially perpendicular to the coupling direction of the first case and the second case, and the positioning projection is formed along the coupling direction. This ensures that at the time of coupling both the eases, in the coupling direction the fastening load can be received widely by the clamp surfaces free of the rib, and the rib can be deformed, to have a fastening allowance, at parts which are not in the fastening direction. In addition, in the coupling direction the clamp surfaces make direct contact with the handlebar, so that the handle switch can be positioned accurately.

According to an embodiment of the present invention, the curvature of the clamp surface is set to be smaller than the curvature of the outer circumferential surface of the handlebar. Therefore, the handlebar can be easily engaged with the clamp surfaces, and the handle switch assembling operation is facilitated.

According to an embodiment of the present invention, the rib is formed in a small-width elongate shape extending in the circumferential direction of the clamp surfaces. Therefore, it is easy to obtain, for example, a shape wherein shape and strength are varied continuously. In addition, even in the case where the switch case is formed from resin or the like by use of a mold, demolding is easy to carry out, and fine adjustment of the rib shape is easy to perform.

According to an embodiment of the present invention, the first case and the second case are coupled together at a parting face substantially perpendicular to the coupling direction of the first case and the second case, and the rib is formed in such a shape that its height decreases as one goes away from the parting face. Therefore, in the case where the gap between the handlebar and the clamp surface is set to be maximized in the vicinity of the parting face, a rib conforming to the shape of the gap that is gradually reduced as one goes away from the parting face can be obtained, so that an efficient sealing treatment can be achieved.

According to an embodiment of the present invention, the rib is formed in such a shape that its width decreases as one goes away from the parting face. Therefore, it is possible to obtain a rib conforming to the shape of a gap which gradually decreases as one goes away from the parting face.

According to an embodiment of the present invention, the parting face is provided with an offset along the direction of coming away from the rider, relative to the axis of the handlebar. Therefore, it is possible to secure a large size of the clamp surface of particularly, the case on the rider side on which the number of switches is greater, of the first case and the second case, and thereby to avoid interference between the back surface of each of the switches and the handlebar. Also, it is possible to ensure that the parting face is not easily visible to the rider.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an enlarged view of a part of a motorcycle based on application of a handle switch according to an embodiment of the present invention;

FIG. 2 is a perspective view of the handle switch as viewed from the rider's side (the rear side of the vehicle);

FIG. 3 is a perspective view of the handle switch as viewed from the front side of the vehicle;

FIG. 4 is a side view of the handle switch;

FIG. 5 is an enlarged view of a part of FIG. 4;

FIG. 6 is a perspective view, as viewed from the vehicle body front side, of a clamp hole on the vehicle body right side of the handle switch;

FIG. 7 is a perspective view, as viewed from the vehicle body rear side, of the clamp hole on the vehicle body right side of the handle switch;

FIGS. 8(a) to 8(c) show illustrations of sectional shapes of ribs; and

FIGS. 9(a) to 9(c) show illustrations of side view shapes of ribs.

### DETAILED DESCRIPTION OF THE PREFERRED EMBODIMENTS

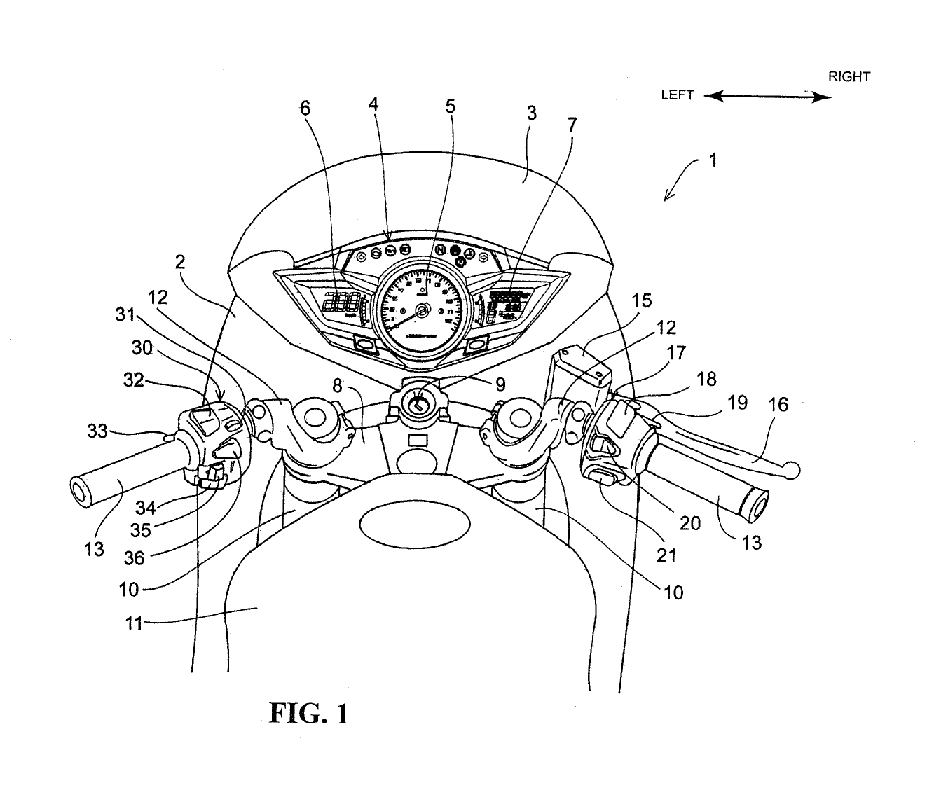

A preferred embodiment of the present invention will be described in detail below, referring to the drawings. FIG. 1 is an enlarged view of a part of a motorcycle 1 based on application of a handle switch 30 according to one embodiment of the present invention. This view shows a handle and the surroundings thereof as viewed from a rear upper side of the vehicle body, and shows substantially the same state as the state viewed from a driver seated on a seat.

The vehicle body front side of a steering handle 12 for steering a front wheel (not shown) is covered with a cowling 2. A windscreen 3 is mounted to an upper end portion of the cowling 2. A meter unit 4 having a tachometer 5, a left-side liquid crystal panel 6 for displaying vehicle speed and the like, and a right-side liquid crystal panel 7 having an odometer and the like is disposed on the lower side of the windscreen 3.

The front wheel of the motorcycle 1 is rotatably supported on lower ends of a pair of left and right front forks 10, and upper portions of the front forks 10 are connected and fixed by a top bridge 8 to which a main switch 9 is mounted. The top bridge 8 is turnably mounted to a body frame (not shown) of the motorcycle 1 through a steering stem which is not shown. The steering handle 12 is fixed to upper end portions of the front forks 10. A fuel tank 11 is disposed between the top bridge 8 and a seat which is not shown.

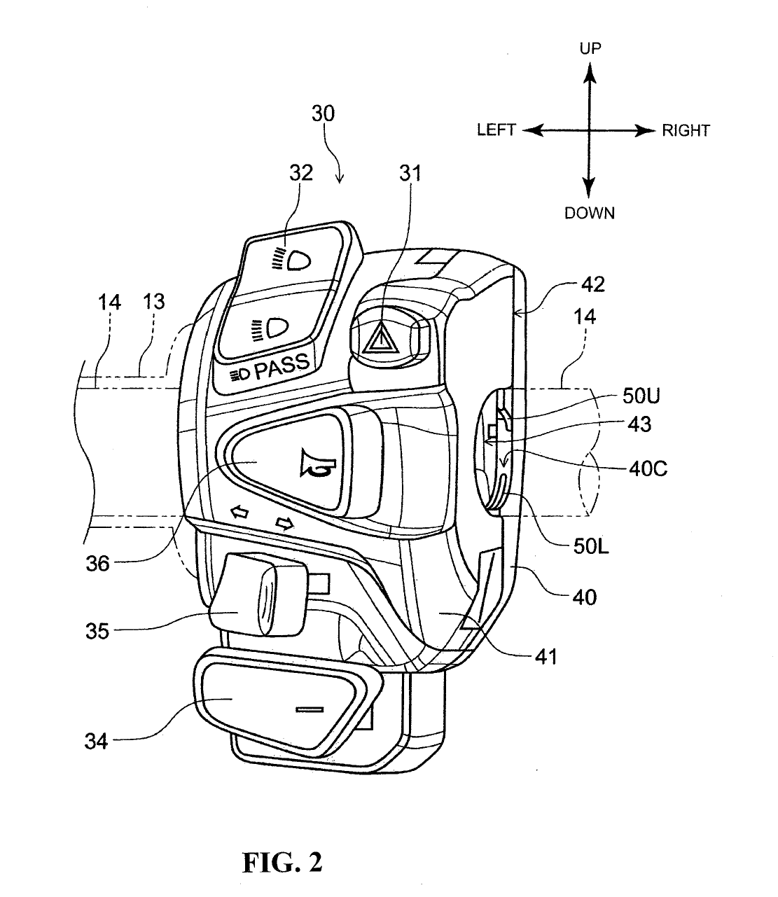

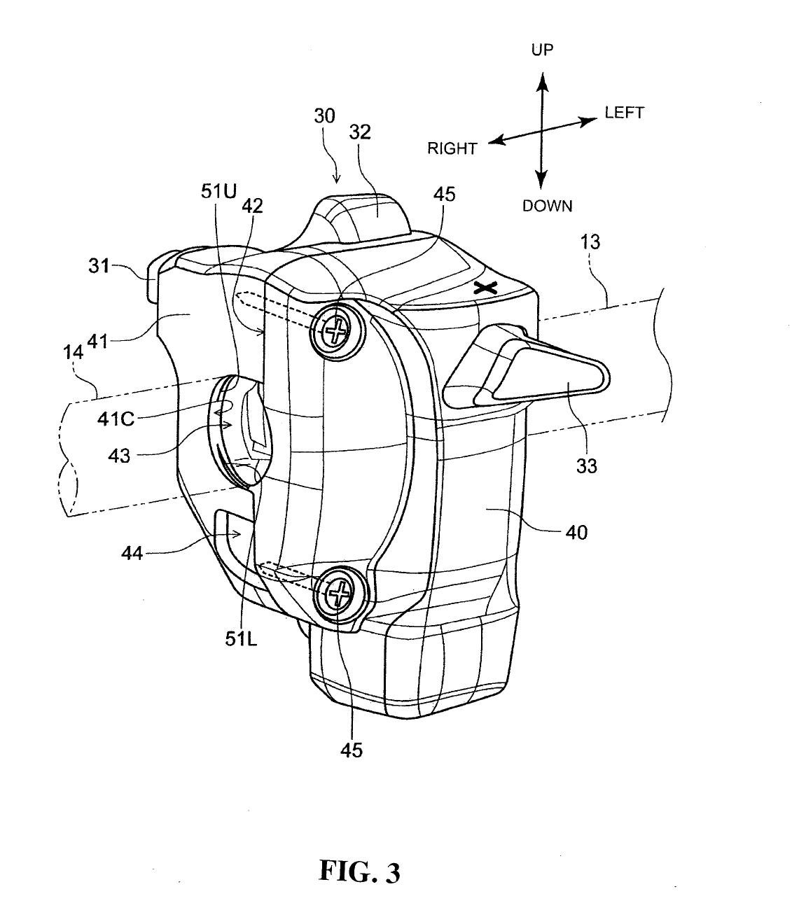

Handle grips 13 formed in tubular shape from rubber or the like are attached to a handlebar 14 (see FIG. 2) connected to the left and right steering handles 12. A front-wheel brake lever 16 is disposed on the vehicle body front side of the handle grip 13 on the right side, and a reservoir tank 15 for reserving a working oil of a hydraulic brake system is attached to a base portion of the front-wheel brake lever 16. In addition, the handle grip 13 on the right side is supported on a cylindrical holder (not shown) which is turnable relative to the handlebar 14, and a throttle device is operated by a turning operation of the handle grip 13.

Onto the steering handle 12 on the right side, a right-side handle switch 17 provided with operation switches for various electrical units is mounted, adjacently to and on the vehicle body center side of the handle grip 13. The motorcycle 1 according to this embodiment has a twin clutch type transmission in which automatic gear shifting of a sequential transmission is enabled, without disconnection of rotational power of an engine, through cooperation of two clutches driven by an actuator. The right-side handle switch 17 is provided with a neutral/drive change-over switch 20 concerning a gear shifting operation and a running mode change-over switch 19, in addition to an engine stop switch 18 and a starter switch 21.

The running mode change-over switch 19 which is of a swing depression type (returning into its initial position when a depressing force thereon is released) and is mounted on the vehicle body front side is a switch to be operated by urging (pulling) to the rider's side by the rider's right index finger. Each time the running mode change-over switch 19 is operated once, change-over between settings for an automatic running mode and for a semi-automatic running mode is conducted.

The neutral/drive change-over switch 20 of a seesaw type (returning into its neutral position when a depressing force thereon is released) is a switch for change-over between neutral (N) and first gear (D) of the automatic transmission upon depressing of the left D side or the right N side thereof when the motorcycle 1 is stopped. In this embodiment, a configuration is adopted wherein when the D side (the left side in the drawings) of the neutral/drive change-over switch 20 is depressed while the automatic running mode is being selected, the running mode is changed over to a sport running mode (S mode) in which more importance is given to a driving force than in the ordinary automatic running mode (D mode).

On the other hand, onto the steering handle 12 on the left side, a left-side handle switch 30 provided with a plurality of operation switches is mounted, adjacently to and on the vehicle body center side of the handle grip 13. The left-side handle switch 30 is provided with a headlight optical axis change-over switch 32, a horn switch 36, a turn signal lamp switch 35, a hazard lamp switch 31, and an up-shift switch 33 and a down-shift switch 34 for gear shifting of the transmission.

FIG. 2 is a perspective view of the left-side handle switch 30, as viewed from the rider's side (the vehicle rear side). The left-side handle switch 30 is fixed to the handlebar 14 extending from the steering handle 12 by a structure wherein the handlebar 14 is clamped from the front and rear sides by switch cases of bisection type, which are coupled together. The switch case is formed with a clamp hole 43 for clamping the handlebar 14 therein.

The swing depression type horn switch 36 is disposed at substantially the same height as the handlebar 14, and the seesaw type optical axis change-over switch 32 is disposed at an upper side thereof. On the vehicle-width-directionally right side of the optical axis change-over switch 32, the hazard lamp switch 31 is disposed of which the on/off state is changed over by causing an operating element to protrude or retract. On the lower side of the horn switch 36, the turn signal lamp switch 35 is disposed which is to be tilted to the left or the right to thereby operate turn signal lamps.

The optical axis change-over switch 32 is of a seesaw type in which it is swung with a swinging shaft as a center; when it is swung to the vehicle body front side, the headlight is tilted upward (high beam), and when it is swung to the vehicle body rear side, the headlight is tilted downward (low beam). In addition, when the optical axis change-over switch 32 is pressed further from the low-beam position to the rider's side, a passing beam is provided by use of the high beam. Besides, the horn switch 36 has a swinging shaft at an end portion on the vehicle-width-directionally outer side, and is swung when an operating surface on the vehicle body inner side is pressed toward the vehicle body front side.

The switch case formed in a box-like shape from resin or the like by injection molding is of bisection structure (composed of two case halves), including a front-side case half 40 as a “first case” located on the vehicle body front side, and a rear-side case half 41 as a “second case” located on the vehicle body rear side (the rider side). The case halves 40 and 41 are coupled together by two fastening screws 45 inserted from the front side of the front-side case half 40. Attendant on the coupling, the case halves 40 and 41 are connected together at a parting face 42, and the handle switch 30 is fixed to the handlebar 14.

The handlebar 14 is held by the inner circumferential surface of the clamp hole 43, which is formed ranging from one to the other of the case halves 40 and 41. The inner circumferential surface is composed of a clamp surface 40C provided in the front-side case half 40 and a clamp surface 41C provided in the rear-side case half 41. The clamp surfaces 40C and 41C are provided thereon with projection-like ribs, which function as a fastening allowance in coupling the case halves 40 and 41 together.

More specifically, the clamp surface 40C of the front-side case half 40 is provided with an upper-side rib 50U and a lower-side rib 50L. On the other hand, the clamp surface 41C of the rear-side case half 41 is provided with an upper-side rib 51U and a lower-side rib 51L. Such a rib structure is similarly applicable also to the clamp surfaces located on the vehicle-width-directionally outer side, and to the right-side handle switch 17. In addition, on the lower side of the clamp hole 43 on the vehicle-width-directionally inner side, a leading-out port 44 for a harness in which wirings connected to the switches are bundled is provided.

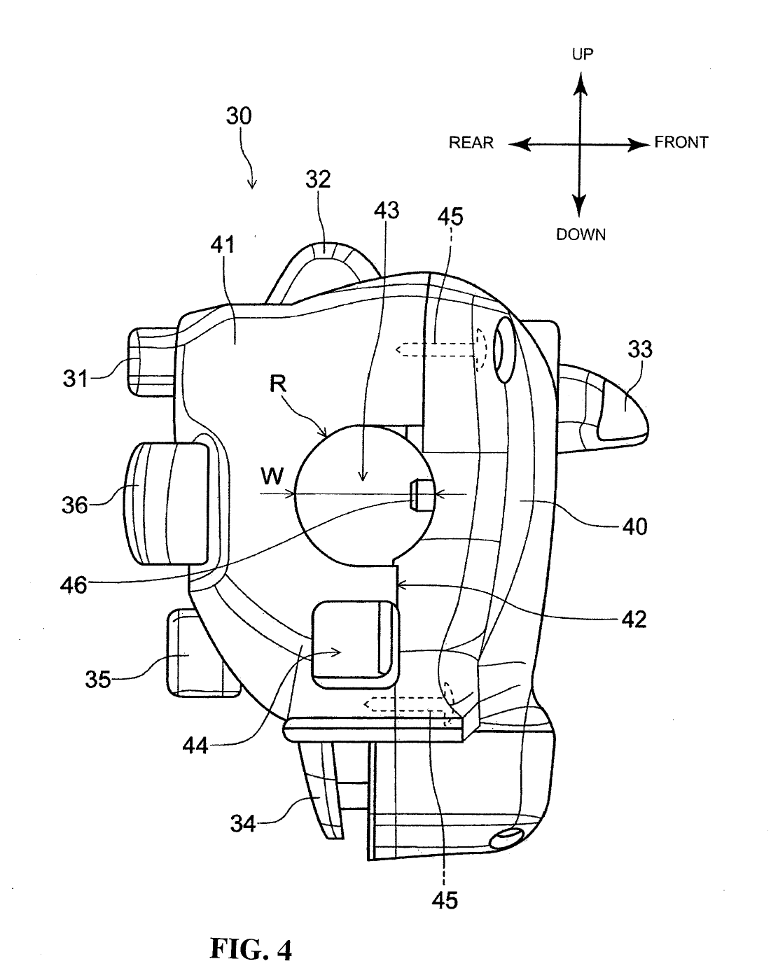

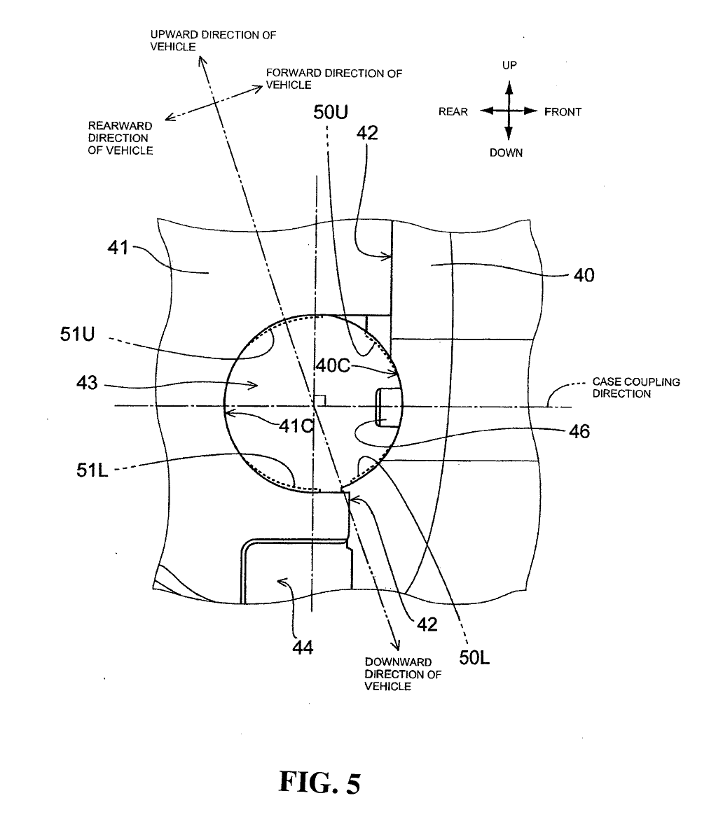

FIG. 4 is a side view of the handle switch 30. In addition, FIG. 5 is an enlarged view of a part of FIG. 4. Both the drawings show the state as viewed from the vehicle-width-directionally inner side. In addition, in FIG. 5, not only arrows indicative of the forward, rearward, upward and downward directions of the handle switch 30 taken alone with reference to the parting face 42, but also the forward, rearward, upward and downward directions of the vehicle when the handle switch 30 is mounted to the vehicle are shown. The parting face 42 of the case halves 40 and 41 is provided in the direction perpendicular to the case coupling direction which is parallel to the front-rear direction of the handle switch 30 taken alone. In addition, the parting face 42 is provided with an offset toward the side of the front-side case half 40 which supports only the up-shift switch 33. The handle switch 30 is mounted to the handlebar 14, with the case coupling direction inclined forwardly downward in relation to the front-rear direction (longitudinal direction) of the vehicle.

The front-side front half 40 is provided with a cylindrical positioning projection 46 projecting toward the vehicle body rear side. The positioning projection 46 is disposed on the inner side relative to the clamp surface 40C. At the time of mounting the handle switch 30 to the handlebar 14, the fastening screws 45 are tightened in the condition where the positioning projection 46 is engaged with a positioning hole (not shown) formed in the handlebar 14.

Referring to FIG. 4, in the case of making a switch case of bisection structure, normally, the curvature R of the clamp surfaces is set so that it is smaller than the curvature of the outer circumferential surface of the handlebar (that the clamp surfaces are greater in radius of curvature). In other words, that the clamp surfaces have an arcuate shape with a greater radius, in order to facilitate engagement of the switch case with the handlebar. Further, in the case where the switch case parting direction is in the front-rear direction, the inner width W of the clamp hole in the front-rear direction is set to be smaller than the outer shape of the handlebar, in order that a frictional force is generated when the fastening screws are tightened.

In addition, with such a dimensional setting applied, a gap between the clamp hole and the handlebar is generated in the vertical direction, and the gap would cause chattering of the switch case. The rib structure according to the present invention is made so as to cope with such a problem and by taking assembleability into account, whereby chattering of the switch case can be prevented even in the case where the above-mentioned dimensional setting is applied.

The plurality of ribs provided at the clamp surfaces 40C and 41C are deformed by being pressed by the outer circumferential surface of the handlebar 14 due to the tightening forces on the fastening screws 45, at the time of coupling the case halves 40 and 41 together with the handlebar 14 clamped therebetween; thus, the ribs function to fill up the gaps between the outer circumferential surface of the handlebar 14 and the clamp surfaces 40C, 41C. In order to easily realize this function, each of the ribs according to this embodiment is formed in a shape having a width smaller than the width (the dimension in the direction along the axial direction of the handlebar 14) of the clamp surfaces 40C, 41C.

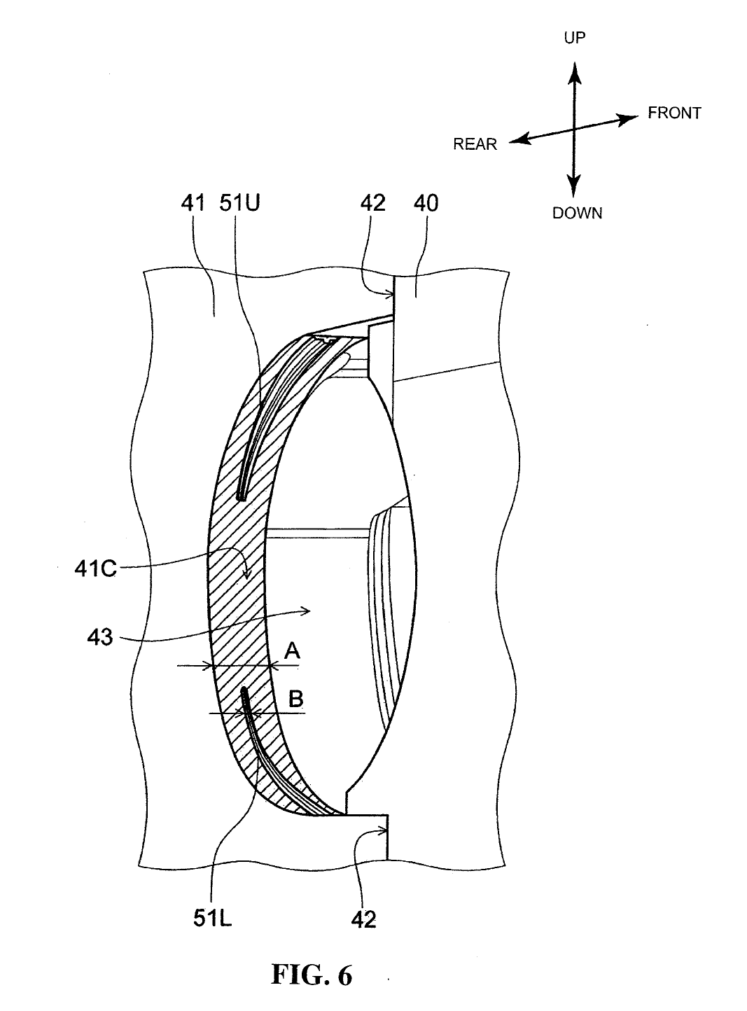

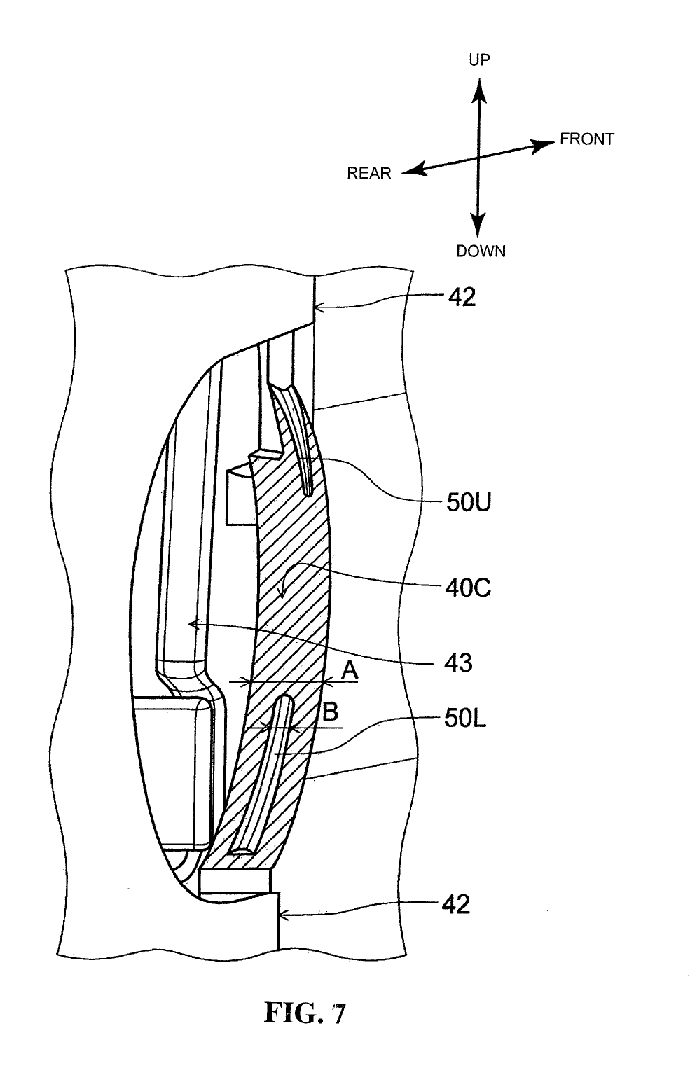

FIG. 6 is a perspective view, as viewed from the vehicle body front side, of the clamp hole 43 on the vehicle body right side in the handle switch 30. In addition, FIG. 7 is a perspective view of the same clamp hole 43, as viewed from the vehicle body rear side. In this embodiment, a characteristic resides in that the width (widthwise dimension) B of each rib is set to be smaller than the width (widthwise dimension) A of each clamp surface. This ensures that the ribs can be easily deformed when the fastening screws 45 are tightened, so that chattering of the switch case 30 can be prevented while maintaining good assembleability.

In addition, in this embodiment, the front-side case half and the rear-side case half are formed from resin or the like by injection molding. In the drawings, the width A of each of the clamp surfaces 40C and 41C indicated by hatching in the drawings corresponds to the plate thickness of the switch case.

In addition, the ribs are each so disposed as to fill up the gap formed between the clamp hole 43 and the handlebar 14 in the vertical direction, and the ribs are not provided in the front-rear direction of the handle switch 30. In other words, the ribs are not provided at those surfaces of the clamp surfaces 40C, 41C which are substantially perpendicular to the coupling direction of the cases 40, 41. This ensures that in the surroundings of the positioning projection 46 the clamp surface 40C makes direct contact with the handlebar 14, whereby accurate positioning is achieved, and easy tightening of the fastening screws 45 can be realized.

The ribs according to this embodiment are molded integrally with the case halves 40, 41, their projection amount is greatest in the vertical direction of the handle switch 30, and they are each formed in a small-width elongate wedge-like shape the height of which gradually decreases as one goes along the circumferential direction away from the greatest-height part. Such a rib shape makes it possible to obtain ribs conforming to the gap shape which is gradually reduced as one goes along the circumferential direction away from the top or bottom position of the clamp hole 43. Consequently, an efficient coupling treatment can be performed.

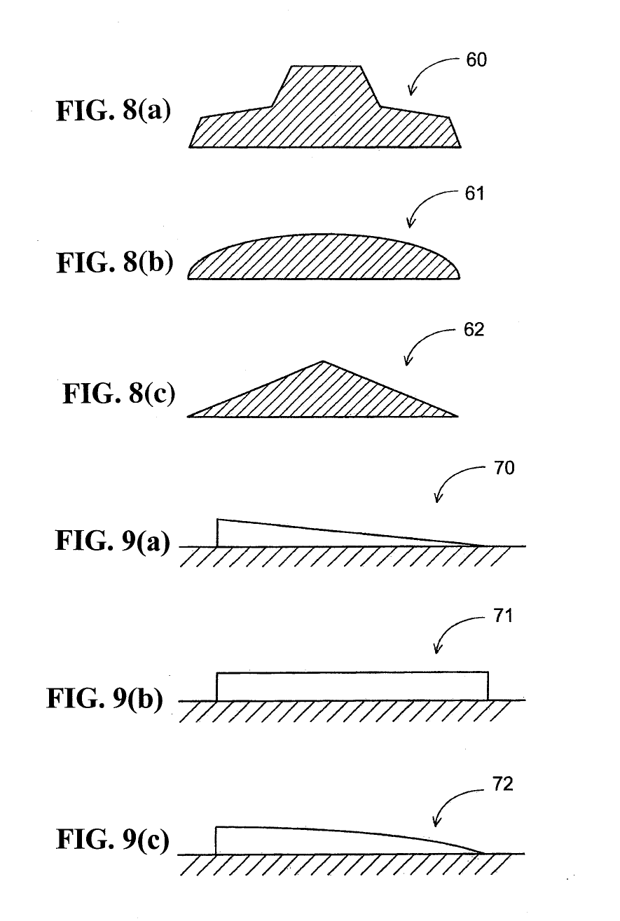

FIGS. 8(a) to 8(c) show illustrations of sectional shapes of ribs. In addition, FIGS. 9(a) to 9(c) show illustrations of side view shapes of ribs. The ribs 50U, 50L 51U and 51L shown in the above embodiment have had a stepped sectional shape 60 as shown in FIG. 8(a) and a side view shape with a rectilinearly decreasing height as shown in FIG. 9(a). However, this is not restrictive, and various modifications are possible. For example, the sectional shape may be a semi-circular sectional shape 61 as shown in FIG. 8(b), or a triangular sectional shape 62 as shown in FIG. 8(c). In addition, the side view shape may be a constant-height side view shape 71 as shown in FIG. 9(b), or a side view shape 72 decreased in height in a curved-line manner as shown in FIG. 9(c).

As above-described, in the handle switch according to the present invention, the switch case of a bisection structure composed of the front-side case half 40 and the rear-side case half 41 is fixed to the handlebar 14 by coupling the case halves together, with the handlebar 14 clamped therebetween. In this handle switch, the clamp surface 40C of the front-side case half 40 and the clamp surface 41C of the rear-side case 41 are provided with the ribs 50U, 50L, 51U and 51L having the width B which is smaller than the width A of the clamp surfaces 40C, 41C. Therefore, it is possible to reduce the fastening force for the cases for filling up the gaps between the handlebar and the clamp surfaces with the ribs, and to prevent chattering of the switch case, without lowering the assembleability of the handle switch.

In addition, the shapes and structures of the handle switch and the switch case, the kinds and number of the switches provided in the handle switch, the shapes of the clamp hole and the clamp surfaces provided in the switch case, the number and shape of the ribs provided at the clamp surfaces, the ratio between the clamp surface width and the rib width, the shape and layout of the positioning projection in the switch case, and the like, are not restricted to those in the above embodiment, and various modifications are possible. The handle switch according to the present invention is applicable not only to motorcycles but also to various vehicles such as three-wheeled or four-wheeled vehicles of saddle type.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A handle switch comprising:
a first case and a second case of a bisection structure formed with clamp surfaces making contact with an outer circumference of a handlebar of a motorcycle, the first case and the second case being coupled together, with the handlebar clamped between the clamp surfaces, to thereby fix the handle switch to the handlebar;
a rib formed in at least one of the clamp surface formed in the first case and the clamp surface formed in the second case, said rib serving as a fastening allowance in coupling the first case and the second case together; and
a width of the rib is smaller relative to a width of the clamp surfaces.

2. The handle switch according to claim 1, wherein the rib is not formed on those surfaces of the clamp surfaces that are substantially perpendicular to a coupling direction of the first case and the second case, and a positioning projection is formed in the coupling direction.

3. The handle switch according to claim 1, wherein the curvature of the clamp surfaces is set to be smaller than the curvature of an outer circumferential surface of the handlebar.

4. The handle switch according to claim 2, wherein the curvature of the clamp surfaces is set to be smaller than the curvature of an outer circumferential surface of the handlebar.

5. The handle switch according to claim 1, wherein the rib is formed in a small-width elongate shape extending along a circumferential direction of the clamp surfaces.

6. The handle switch according to claim 2, wherein the rib is formed in a small-width elongate shape extending along a circumferential direction of the clamp surfaces.

7. The handle switch according to claim 3, wherein the rib is formed in a small-width elongate shape extending along a circumferential direction of the clamp surfaces.

8. The handle switch according to claim 1,
wherein the first case and the second case are coupled together at a parting face substantially perpendicular to the coupling direction of the first case and the second case, and
the rib is formed in such a shape that its height decreases as one goes away from the parting face.

9. The handle switch according to claim 2,
wherein the first case and the second case are coupled together at a parting face substantially perpendicular to the coupling direction of the first case and the second case, and
the rib is formed in such a shape that its height decreases as one goes away from the parting face.

10. The handle switch according to claim 3,
wherein the first case and the second case are coupled together at a parting face substantially perpendicular to the coupling direction of the first case and the second case, and
the rib is formed in such a shape that its height decreases as one goes away from the parting face.

11. The handle switch according to claim 5,
wherein the first case and the second case are coupled together at a parting face substantially perpendicular to the coupling direction of the first case and the second case, and
the rib is formed in such a shape that its height decreases as one goes away from the parting face.

12. The handle switch according to claim 8, wherein the rib is formed wherein its width decreases as one goes away from the parting face.

13. The handle switch according to claim 8, wherein the parting face is provided with an offset along a direction of coming away from a rider, relative to an axis of the handlebar.

14. The handle switch according to claim 12, wherein the parting face is provided with an offset along a direction of coming away from a rider, relative to an axis of the handlebar.

15. A handle switch comprising:
a first case and a second case of a bisection structure fanned with clamp surfaces therebetween, the first case and the second case being coupled together for fixing the handle switch to a handlebar;
a rib formed on one of the clamp surface formed in the first case and the clamp surface formed in the second case, said rib serving as a fastening allowance in coupling the first case and the second case together; and
a width of the rib is smaller relative to a width of the clamp surfaces.

16. The handle switch according to claim 15, wherein the rib is not formed on surfaces of the clamp surfaces being substantially perpendicular to a coupling direction of the first case and the second case, and a positioning projection is formed in the coupling direction.

17. The handle switch according to claim 15, wherein the curvature of the clamp surfaces is set to be smaller than the curvature of an outer circumferential surface of the handlebar.

18. The handle switch according to claim 15, wherein the rib is formed in a small-width elongate shape extending along a circumferential direction of the clamp surfaces.

19. The handle switch according to claim 15,
wherein the first case and the second case are coupled together at a parting face substantially perpendicular to the coupling direction of the first case and the second case, and
the rib is formed in such a shape that its height decreases as one goes away from the parting face.

20. The handle switch according to claim 19, wherein the rib is formed wherein its width decreases as one goes away from the parting face.
